(19) United States
(12) Patent Application Publication
(10) Pub. No.: US 2026/0326806 A1
(43) Pub. Date: Oct. 22, 2026

(54) MODULAR ASSEMBLY ALLOWING FOR CONSTITUTION OF STROLLER AND WHEELED VEHICLE FOR CHILDREN

(71) Applicants: ID DEVELOPEMENT LIMITED, East KOWLOON (HK); DESIGN OFFICE, LYON (FR)

(72) Inventors: Joseph MAZOYER, SAINTE FOY LES LYON (FR); Philippe BAJARD, LYON (FR)

(21) Appl. No.: 19/107,577

(22) PCT Filed: Oct. 15, 2023
(86) PCT No.: PCT/FR2023/000154

§ 371 Date: Feb. 28, 2025

(30) Foreign Application Priority Data
Oct. 28, 2022 (FR) FR2211271

(51) Int. Cl. B62B 7/12; B62B 9/10; B62B 9/20

(52) U.S. Cl. CPC B62B 7/12; B62B 9/102; B62B 9/20

(57) ABSTRACT

The invention relates to an assembly of modular elements allowing either to constitute a stroller (2) or to obtain a wheeled vehicle (3) suitable for being ridden by a child. The assembly includes:—a seat (5)/push handle (6) subassembly, a base plate (15) of the seat (5) being connected to the handle (6) while being movable relative to the handle (6) between an unfolded state and a folded state; and—a wheeled vehicle (3), which forms a chassis and wheels of the stroller (2) in a “stroller” configuration, where the plate (15) is dimensioned in such a manner that, in the unfolded position, it rests on a gripping handle (20) that the vehicle (3) includes, and, in the folded state, it allows for clearance of a part of the vehicle (3) intended to be ridden by a child.

### TECHNICAL FIELD

The present invention relates to an assembly of modular elements, allowing, depending on the assembly configuration of the elements, either to constitute a stroller or to obtain a wheeled vehicle suitable for being ridden by a child.

### BACKGROUND

It is useful for a parent to have, in close succession, a stroller to transport a child, for example from a home to a kindergarten, and a wheeled vehicle, so that the child can play with this vehicle, for example once they arrive at the kindergarten.

Currently, a stroller and a wheeled vehicle for children are separate objects, which can be used alternately. As a result, when the child is being transported by the stroller, the parent must carry the wheeled vehicle, which is a significant burden considering the weight and bulk of such a vehicle.

### SUMMARY

There is currently no satisfactory solution on the market to this problem, and the main objective of the present invention is to provide such a solution, namely, to provide an assembly of elements as mentioned above, allowing for a simple and quick transition from the “stroller” configuration to the “vehicle” configuration.

An additional objective of the invention is to provide an assembly of elements as mentioned above, allowing the stroller to be folded in a reduced volume in order to facilitate the storage or transport of this assembly when not in use.

An additional objective of the invention is to provide an assembly of elements as mentioned above, allowing to obtain the stability required for the stroller without limiting the possibilities of use of the vehicle by the child or increasing the volume occupied by the assembly of elements in the folded state.

In order to achieve at least the aforementioned main objective, the assembly of elements according to the invention includes:
a subassembly formed by a stroller seat and a stroller push handle, the seat including a base and a backrest, the base being connected to the push handle and movable relative to the push handle between an unfolded state relative to the handle, in which the base is suitable for receiving a child, and a folded state, in which the base is close to and extending along the handle; and
a wheeled vehicle for a child, which forms a chassis and wheels of the stroller in a “stroller” configuration, the vehicle including a body suitable for being ridden by a child, the body including, at its front part, a gripping handle suitable for being gripped by a child riding the body, and including means for mounting the push handle to the body, wherein
   the base is dimensioned to rest on the gripping handle in the unfolded state, thus allowing stable support of the base by the gripping handle; and in the folded state, the base allows for clearance of a part of the vehicle intended to be ridden by a child.

As can be understood, the wheeled vehicle is integrated into the stroller as a rolling chassis of this stroller. As a result, a parent, when transporting a child in a stroller and also wanting to have a wheeled vehicle available for the child's amusement, does not have to carry the wheeled vehicle in addition.

In its unfolded position, the base can receive the child in a stable and secure manner; and in the folded position of this base, the child can ride the vehicle and be pushed by the parent by means of the push handle.

The seat/push handle subassembly might not be removable relative to the body of the vehicle; however, this would result in the disadvantage that the child could only have fun with the seat/push handle subassembly mounted on the wheeled vehicle, thus with a certain bulk and weight; therefore, preferably, the means for mounting the push handle onto the body of the vehicle are designed so as to allow removable mounting of the seat/push handle subassembly.

This subassembly can therefore be dismantled relative to the wheeled vehicle, thus allowing the child to have a vehicle including only the body, the wheels and the gripping handle.

The base could simply rest on the gripping handle; preferably, however, in order to prevent any risk of unintended movement of the base in certain situations, particularly in the event of the stroller overturning, the assembly of elements includes means for connecting the base to the gripping handle.

According to one possibility in this case,
the gripping handle is T-shaped, i.e., has an upper bar forming the equivalent of a “handlebar”, the upper bar including first connecting means at its ends, and
the base has lateral parts capable of covering the ends of the upper bar and has, at the lateral parts, second connecting means capable of engaging with the first connecting means to achieve the connection of the base to the gripping handle.

The first connection means in question may, for example, be constituted by holes having screw threads arranged in the ends of the upper bar, and the second connection means are then constituted by screws capable of passing through the lateral parts of the base and of being screwed into the holes.

According to a preferred embodiment of the invention,
the push handle has lower parts connected to upper parts by pivoting connections, the pivoting connections allowing the push handle to be placed either in an unfolded state, for pushing the stroller, or in a folded state, in which the lower parts and the upper parts are placed in a position close to the body of the wheeled vehicle, along lateral sides of the body; and
the base is pivotally connected to the pivoting connections by means of mounting foils which offset the plane formed by the base relative to the pivot axes formed by the pivoting connections, this offset allowing the base to cover the body of the vehicle in the folded state.

The assembly of elements according to the invention can thus adopt a reduced volume in this folded position, allowing for easy storage or transport.

Preferably, the gripping handle can be placed in two vertically staggered positions, namely a lowered position, allowing to reduce the footprint of the assembly of elements when not in use, and an elevated position, allowing to position the gripping handle at a height suitable for gripping by the child riding the vehicle.

This arrangement allows to further reduce the volume occupied by the assembly of elements when not in use.

According to a possible embodiment of the invention in this case, the gripping handle includes a column forming a tubular portion while the body of the vehicle forms a tubular extension receiving the tubular portion in a telescopic manner, and includes immobilization means allowing to immobilize the tubular portion and the tubular extension relative to each other in either of the two aforementioned positions of the gripping handle.

These immobilization means may in particular include respective holes of the tubular portion and of the tubular extension, coinciding with each other in either of the positions, and a locking pin capable of being engaged in these holes, the pin being associated with a spring allowing its mobility between a position of engagement in these holes and a position of disengagement relative to these holes.

According to an alternative embodiment, the gripping handle is pivotally mounted, in particular at its base, on the body of the vehicle, so as to be able to pivot between an unfolded position, in which it is erected and can be gripped by a child riding the vehicle, and a folded position, in which it is lowered so as to be located near the front of the body of the vehicle, fixing means being provided to maintain the handle at least in the unfolded position.

For the same purpose of reducing the footprint of the assembly according to the invention when not in use, the body of the vehicle may be divided transversely into two parts, namely a front part and a rear part, these parts being connected to each another in a pivoting manner, this pivoting allowing mobility of the rear part relative to the front part between an unfolded position of use, in which the rear part extends away from the front part, and a folded storage position, in which the rear part is folded in the direction of the front part along the lower side of the front part.

According to an improved embodiment of the invention, the assembly of elements includes means for positioning rear wheels of the vehicle in two spacing positions, namely a position of greater spacing, which is adopted in the “stroller” configuration of the assembly of elements, and a position of smaller spacing, which is adopted when the wheeled vehicle is used as such or when the assembly of elements is in the folded state.

The greater spacing of the rear wheels provides great stability to the stroller, while the smaller spacing of these same wheels allows the child to use the wheeled vehicle in a way that is not constrained by an excessive spacing of the rear wheels.

Preferably, the push handle includes, at its lower part and on its rear side, a strut connected to a locking block, the block being intended to engage with the body of the vehicle and thus allowing to lock the push handle onto the body in the unfolded state of the handle.

A stable and resistant positioning of the push handle relative to the vehicle is thus obtained.

### BRIEF DESCRIPTION OF DRAWINGS

The invention will be well understood through the following description, made with reference to the attached schematic drawing, the drawing showing, by way of non-limiting example, a possible embodiment of the modular assembly of elements in question.

In this drawing,

FIG. 1 is a perspective view of the assembly of elements in a “stroller” configuration, at a first viewing angle;

FIG. 2 is a perspective view in this same configuration, at a second angle;

FIG. 3 is a view similar to FIG. 1 but with the removal of different fabric pieces of the stroller seat, assembled together, namely a seat fabric, a backrest fabric, a footrest fabric, and side fabrics, as well as the removal of a sun-hood and a safety harness included in the stroller;

FIG. 4 is a view similar to FIG. 2, with the same erasures as in FIG. 3;

FIG. 5 is a view of the assembly of elements similar to FIG. 3, in a folded state of a base included in the stroller seat;

FIG. 6 is a perspective view of the wheeled vehicle for children included in the assembly of elements;

FIG. 7 is a view of the assembly of elements in a folded state;

FIG. 8 is a detailed view, on an enlarged scale and in section, of a pivoting connection connecting a lower part of a branch of the push handle of the stroller and an upper part of this branch;

FIG. 9 is a detailed view, on an enlarged scale and in section passing through the axis of one of the ends of an upper bar including a gripping handle carried by the wheeled vehicle, and showing the base of the stroller seat resting on this gripping handle;

FIG. 10 is a detailed view, on an enlarged scale and in section, of an assembly for mounting one of the branches of the push handle of the stroller onto the body of the wheeled vehicle;

FIG. 11 is a detailed view, on an enlarged scale and in section passing through a locking block allowing to lock the push handle of the stroller in an erected position, the block being in engagement with the body of the vehicle;

FIG. 12 is a view similar to FIG. 11, in a disengaged position of the block relative to the body of the vehicle;

FIG. 13 is a detailed view on an enlarged scale of a lower part of a gripping handle that the wheeled vehicle includes, in section passing through the median plane of this handle;

FIG. 14 is a detailed view, on an enlarged scale and in section passing through the axis of the rear axle of the vehicle and passing through a median plane of a rear part of the body of the vehicle, in a position where the rear wheels of the vehicle are spread apart;

FIG. 15 is a view similar to FIG. 14, in a position in which the rear wheels of the vehicle are brought closer together;

FIG. 16 is a detailed view, on an enlarged scale and in section along a front-rear direction of the vehicle, of one of the two mechanisms for controlling the rear wheels to be brought closer together or spread apart, in a lock position;

FIG. 17 is a view similar to FIG. 16, the mechanisms being in an unlocked position; and

FIG. 18 is a side view of the assembly of elements according to another embodiment, showing an unfolded position of this assembly in solid lines and a partially folded position of this assembly in dashed lines.

### DETAILED DESCRIPTION

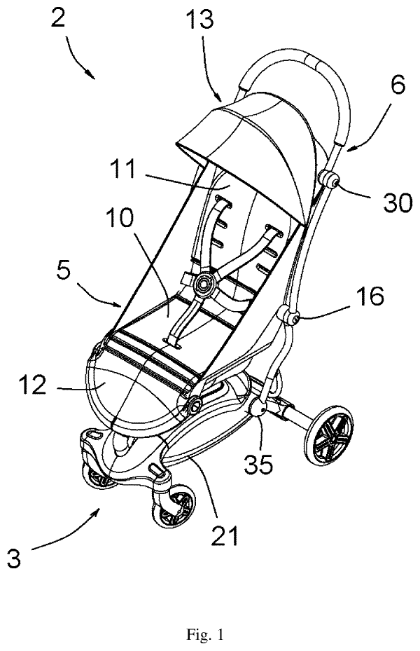

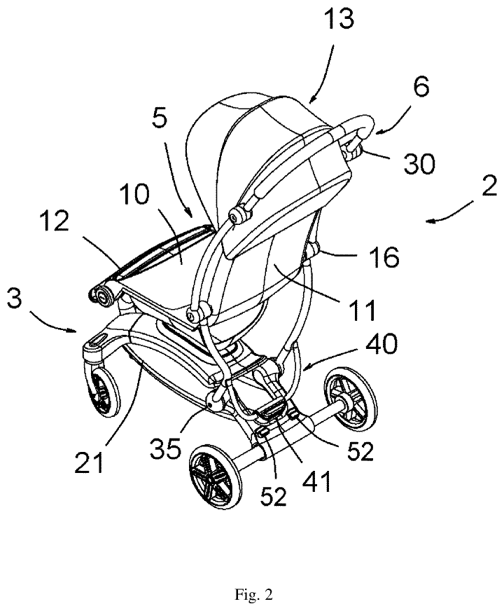

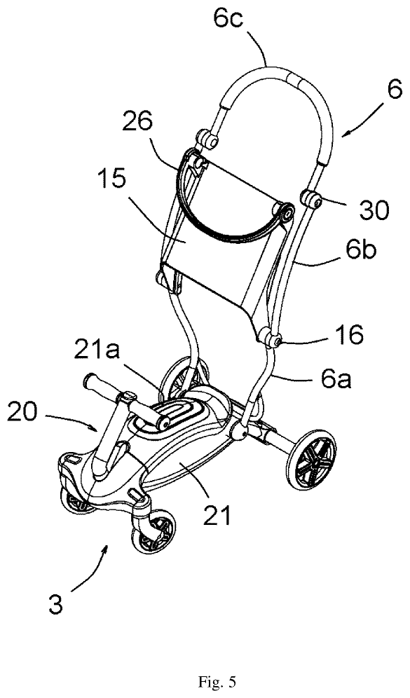

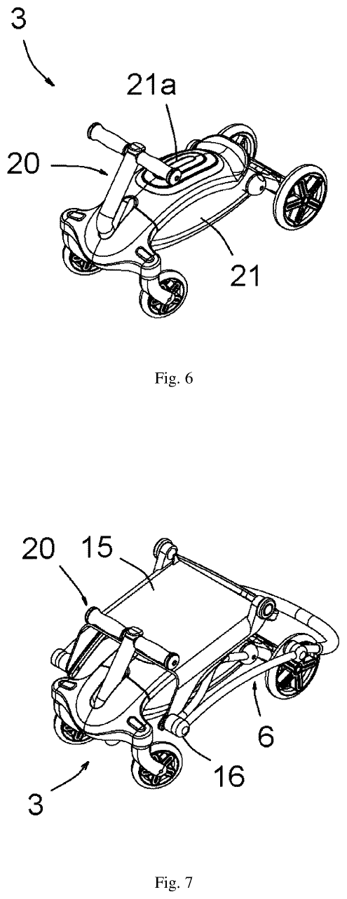

FIGS. 1 and 2 show an assembly of modular elements allowing, in the assembly configuration of the elements shown in these figures, to constitute a stroller 2, and, in another configuration shown in FIGS. 5 and 6, to obtain a wheeled vehicle 3 suitable for being ridden by a child.

The assembly of elements includes (i) a subassembly 5, 6, formed by a stroller seat 5 and a stroller push handle 6, and (ii) the wheeled vehicle 3, which constitutes the rolling chassis of the stroller 2.

### Description of Seat 5

The seat 5 of the stroller 2 includes a base 10 and a backrest 11, as well as, in the example shown, a front part 12 forming a footrest, and a sun-hood 13.

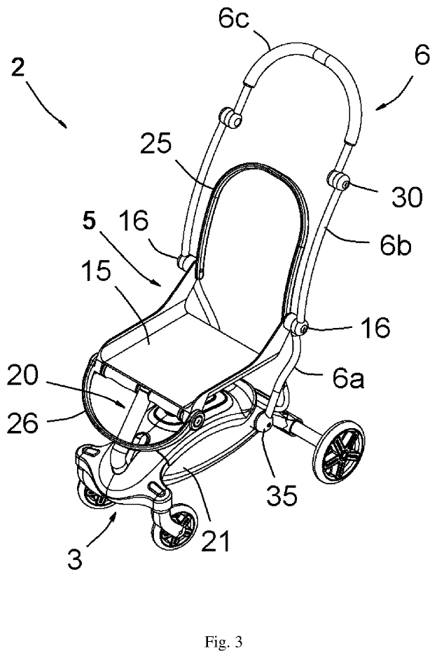

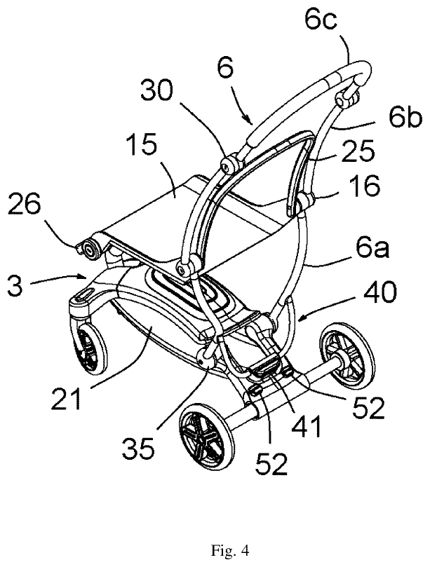

As can be understood with reference to FIGS. 3 and 4 in comparison with FIGS. 1 and 2, these different seat parts 10 to 12 include assembled fabric pieces, carried by support structures 15, 25, 26, these fabric pieces being erased in FIGS. 3 and 4 in order to make these support structures visible. The sun-hood 13 is also erased in FIGS. 3 and 4.

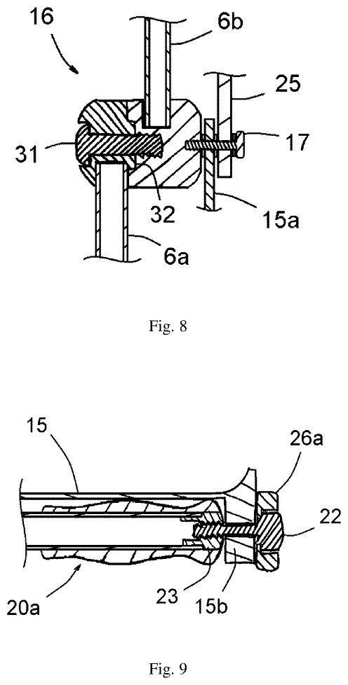

It can thus be seen that the base 10 includes, in addition to the fabric piece, a plate 15 having two lateral cheeks on its rear part, by means of which the base 10 is pivotally mounted on the push handle 6. This pivoting mounting is made at the pivoting connections 16 which connect lower parts 6a of the lateral branches of the handle 6 to upper parts 6b of these same branches. One of the connections 16 is more particularly visible in section in FIG. 8; and it can be seen that each lateral cheek 15a of the plate 15 is connected to one of the two parts forming the connection 16 by means of a screw 17, in a pivoting manner.

The lateral cheeks 15a allow the plane of the base formed by the plate 15 to be offset relative to the pivot axes formed by the connections 16; as can be seen in FIG. 7, in the folded position, the lower parts 6a and upper parts 6b extend along the lateral sides of the body 21 of the vehicle 3, with the connections 16 located near the front wheels of the vehicle 3; and the offset allows, in this folded state, the base 10 to cover the body 21 of the vehicle 3. The assembly of elements thus has a reduced footprint.

The pivoting of the base 10, and therefore the plate 15, relative to the handle 6 takes place between an unfolded state relative to this handle, visible in FIGS. 1 to 4, in which the base 10 can receive a child, and a folded state, visible in FIG. 5, in which the plate 15 is elevated, thus being close to the handle 6. It can also be seen that the plate 15 is dimensioned in such a manner that, in the unfolded position, it comes to rest against an upper transverse bar including a gripping handle 20 located on the front part of the body 21 of the vehicle 3. As can be seen more particularly in FIG. 9, the plate 15 has lateral walls 15b covering the ends of the upper bar 20a of the handle 20, through which screws 22 for assembling the plate 15 to the upper bar 20a pass. Each screw 22 is received by screwing into the threaded hole of a socket 23 housed inside the end of the bar 20a.

The backrest 11, in addition to the fabric piece which is specific to it, includes an arch 25 forming a support frame for this fabric piece. As can be seen in FIG. 8, the arch 25 is mounted on the connection 16 by the same screw 17 as that used for mounting the cheek 15a of the plate 15. When the base 10 is unfolded and connected to the upper bar 20a as described above, the backrest 11 is held in position by the lateral fabric pieces which connect the fabric piece of the base 10 to the fabric piece of the backrest 11.

The front part 12 which forms a footrest also includes, in addition to the fabric piece which is specific to it, an arch 26 for supporting this fabric piece. This arch 12 is pivotally mounted on the front of the base 10, the pivoting being, in the example shown, achieved by means of rounded parts 26a formed at the ends of the arch 26, which are drilled with shouldered holes, these holes receiving the screws 22 as shown in FIG. 9.

The sun-hood 13 is, for its part, of the conventional type and is not part of the invention; and it therefore does not need to be particularly described.

### Description of the Push Handle 6

This handle 6, in addition to the aforementioned lower parts 6a and upper parts 6b, includes an upper arch 6c connected to the upper parts 6b by assembly connections 30 similar to the connections 16. The handle 6 thus has the shape of an elongated handle, forming an upper arch and two lateral branches.

With reference to FIG. 8, it can be seen that each connection 16 is formed by two parts connected by a screw 31, these parts being respectively connected to the respective parts 6a, 6b; and one of the two parts (the one on the left in FIG. 8) has a projecting prismatic part 32 at its assembly face to the other piece, which can be received in a fitted manner in a cavity of corresponding shape which the other piece has. It will be understood that, when the screw 31 is tightened, the prismatic part 32 is kept engaged in the cavity, which ensures the immobilization in rotation of the two pieces forming the connection 16 relative to each other. This pivoting locking position corresponds to maintaining the upper part 6b in the prolonged portion of the corresponding lower part 6a, and therefore in the unfolded state of the handle 6. When the screw 31 of each connection 16 is loosened, the prismatic part 32 can be freed from the cavity, which allows the upper part 6b to pivot relative to the lower part 6a, allowing to fold the handle 6.

As can be seen from a comparison of FIGS. 1 to 4 and 6, the handle 6 is removably mounted on the body 21 of the vehicle 3, so that the subassembly 5, 6 can be removed from this vehicle. The vehicle 3 can then be used for amusement by a child, the latter riding on the body 21 by sitting on a saddle 21a formed on the upper part of this body 21, and gripping the upper bar 20a of the handle 20.

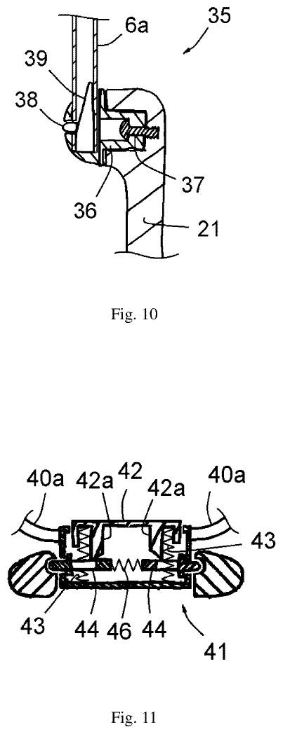

The removable mounting of the handle 6 on the body 21 is achieved by means of pivoting assembly connections 35, one of which is more particularly visible in FIG. 10. As shown in this figure, each connection 35 includes a base 36 receiving the lower part 6a, this base being pivotally mounted in a bearing formed by the body 21 and being retained on this body by means of a screw 37. The lower part 6a is received in a fitted manner in a corresponding hole formed by the base 36, and is retained in this hole by means of a movable pin 38 associated with a leaf spring 39. This pin 38 passes through a hole in the part 6a and a hole in the base 36 to ensure the retention of the part 6a on the base 36, and can be pressed against the elastic force of the spring 39 so as to release the part 6a relative to the base 36.

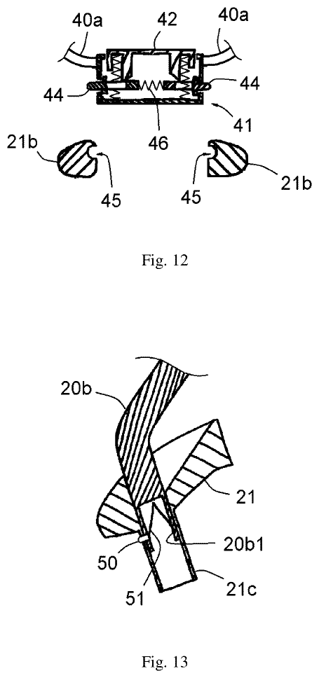

As can be seen in FIGS. 2 and 4, the handle 6 also has, at its lower part and on its rear side, a strut 40 connected to a locking block 41 allowing to lock the handle 6 onto the body 21, in the unfolded state of this handle. In the locked state, this block 41 comes into engagement between two parallel branches formed by the rear part of the body 21 and is engaged with these two branches. The block 41 is more particularly visible in FIGS. 11 and 12; and as shown in these figures, the block 41 is in the form of a housing connected to the two lateral parts 40a of the strut and includes a push button 42 on its upper part, suitable for being pushed into the housing by a user, this push button 42 being associated with two springs 43 which return it to the extended position. The push button 42 forms two studs 42a whose free ends have inclined surfaces so as to form actuation ramps. Each of these free ends is located near an actuation rim of a corresponding sliding latch 44, this latch 44 having an end which passes through the corresponding lateral wall of the housing and which forms a locking pin. This pin can be received in a corresponding locking cavity 45 arranged in one of the aforementioned parallel branches 21b formed by the rear part of the body 21. The two latches 44 are returned to a lock position by a spring 46 extending between them.

As can be understood by comparing FIGS. 11 and 12, from the lock position shown in FIG. 11, pressing the push button 42 will cause the aforementioned actuation ramps to bear against the actuation rims of the latches 44, leading to the retraction of these latches towards the interior of the housing and therefore to the extraction of the locking pins out of the cavities 45 of the branches 21b. The pivoting of the push handle 6 relative to the body 21 of the vehicle is then released, which allows this handle to be brought into the folded state. To lock the block 41 onto the body 21, it suffices, starting from the position shown in FIG. 12, to engage the block 41 between the branches 21b; and rounded portions of the branches 21b near the cavities 45 and corresponding rounded portions arranged at the ends of the locking pins bear against each other during this engagement so as to cause the latches 44 to retract inside the housing, against the elastic force of the spring 46, until the pins are located opposite the cavities 45, in which they then engage under the stress of the spring 46.

### Description of Vehicle 3

By comparing FIGS. 6 and 7, it can be seen that the gripping handle 20 can be placed in two vertically staggered positions, namely a lowered position visible in FIG. 7, for storage, and an elevated position, visible in FIG. 6, allowing the gripping handle 20 to be placed at an adequate height for it to be gripped by a child riding the body 21 of the vehicle 3. The lowered position allows for a reduction in the footprint of the assembly of elements in the storage or transport position shown in FIG. 7.

As shown more particularly in FIG. 13, the handle 20 includes a column 20b whose lower part forms a tubular portion 20b 1, and the body 21 forms a tubular extension 21c in which the portion 20b 1 is received telescopically. The latter and the extension 21c include respective holes which coincide with each other in both of the lowered and elevated positions of the handle 20. A locking pin 50 can be engaged in these holes, this pin being associated with a leaf spring 51 allowing the mobility of the pin 50 between a position of engagement in the coincident holes, allowing the locking of the handle 20 relative to the body 21, and a position of disengagement of the pin 50 relative to these same holes, allowing the telescopic sliding of the column 20b relative to the extension 21 c.

Furthermore, a comparison of FIGS. 1 to 4 with FIGS. 6 and 7 reveals that the rear wheels of the vehicle 3 can be placed in two spaced apart positions, namely a position of greater spacing, visible in FIGS. 1 to 4, which is adopted in the “stroller” configuration, and a position of smaller spacing, visible in FIGS. 6 and 7, which is adopted when the vehicle 3 is used by the child or when the assembly of elements is in the folded state. The greater spacing of the rear wheels provides great stability to the stroller 2, while the smaller spacing of these same wheels allows the child to use the vehicle 3 in a way that is not constrained by an excessive spacing of the rear wheels, and allows a compact folding of the assembly of elements.

This spacing is controlled by means of two slider buttons 52 located on the rear part of the body 21, visible in FIGS. 2 and 4.

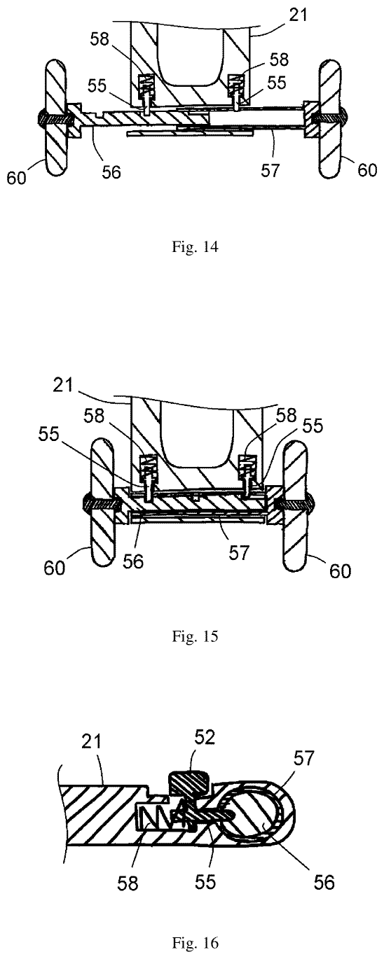

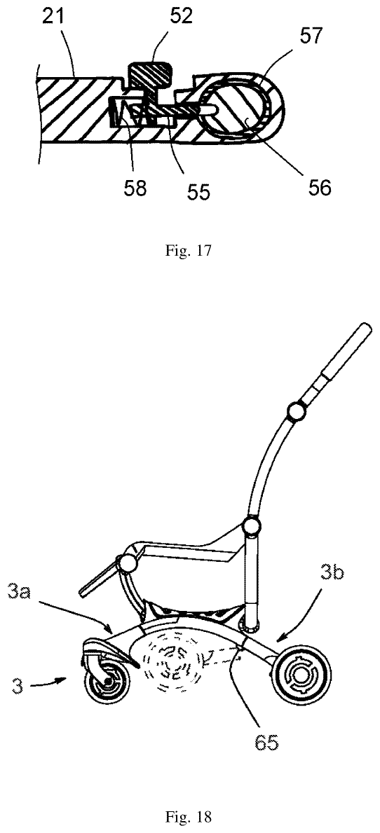

FIGS. 14 to 17 show more particularly the mechanisms of which the buttons 52 form part. As can be seen in FIGS. 16 and 17, these buttons 52 are integral with locking rods 55; and it can be seen in these figures and in FIGS. 14 and 15 that ends in the form of locking pins of these rods 55 can come into engagement in corresponding receiving cavities arranged in a bar 56 and a tube 57 engaged telescopically with each other, this bar 56 and this tube 57 forming the axle of the rear wheels 60 of the vehicle 3. The locking rods 55 are biased by springs 58 into lock positions corresponding to the engagement of the pins in the receiving cavities.

With reference to FIGS. 14 and 15, it will be understood that from the position of the rear wheels 60 spread apart shown in FIG. 14, an action on the slider buttons 52 against the elastic force exerted by the springs 58 on the locking rods 55 allows for the extraction of the pins from the corresponding receiving cavities thereby releasing the sliding of the bar 56 and the tube 57 relative to each other. This sliding can be carried out until the wheels 60 are brought into the close position shown in FIG. 15, in which position the locking pins are engaged in other corresponding receiving cavities, allowing the wheels 60 to be maintained in this close position. To return to the spread-apart position, an action on the slider buttons 52 is exerted so as to disengage the locking pins from the other receiving cavities in order to return the bar 56 and the tube 57 to the spread-apart position of the wheels 60.

FIG. 18 is a view of the assembly of elements according to another embodiment, in which the body of the vehicle 3 is divided transversely into two parts 3a, 3b, namely a front part 3a and a rear part 3b, these parts being connected to each other in a pivoting manner, by a connection 65 forming a hinge with a pivot axis transverse to the body of the vehicle 3. The pivoting made possible by this connection allows mobility of the rear part 3b relative to the front part 3a between an unfolded position of use, shown in solid lines, in which the rear part 3b extends away from the front part 3a, and a partially folded position of storage, shown in dashed lines, in which the rear part 3b is folded in the direction of the front part 3a along the lower side of this front part 3a. The folded position shown in dashed lines is a fully folded position of the part 3b but is a partially folded position in the sense that the push handle, the gripping handle and the base, as shown, are not folded.

It is apparent from the foregoing that the invention provides an assembly of modular elements which remedy the drawbacks of the prior art by allowing to switch from the “stroller” configuration to the “vehicle” configuration in a simple and rapid manner, by allowing the stroller to be folded in a reduced volume in order to facilitate the storage or transport of this assembly when not in use, and by allowing to obtain the stability required for the stroller without limiting the possibilities of use of the vehicle by the child or increasing the volume occupied by the assembly of elements in the folded state.

1. An assembly of modular elements, allowing, depending on the assembly configuration of the elements, either to constitute a stroller (2) or to obtain a wheeled vehicle (3) suitable for being ridden by a child, the assembly comprising:
a subassembly (5, 6) formed by a stroller seat (5) and a stroller push handle (6), the seat (5) comprising a base (10) and a backrest (11), the base (10) being connected to the push handle (6) and movable relative to the push handle (6) between an unfolded state relative to the handle (6), in which the base (10) is suitable for receiving a child, and a folded state, in which the base (10) is close to and extending along the handle (6); and
a wheeled vehicle (3) for a child, which forms a chassis and wheels of the stroller (2) in a “stroller” configuration, the vehicle (3) comprising a body (21) suitable for being ridden by a child, the body (21) comprising, at its front part, a gripping handle (20) suitable for being gripped by a child riding the body (21), and comprising means (35) for mounting the push handle (6) to the body (21), wherein
the base (10) is dimensioned to rest on the gripping handle (20) in the unfolded state, thus allowing stable support of the base (10) by the gripping handle (20); and in the folded state, the base (10) allows for clearance of a part (21a) of the vehicle (3) intended to be ridden by a child.

2. The assembly of claim 1, wherein the means (35) for mounting the push handle (6) to the body (21) of the vehicle (3) are designed to allow for removable mounting of the seat (5)/push handle (6) subassembly.

3. The assembly of claim 1, further comprising means (15b, 22, 23) for connecting the base (10) to the gripping handle (20).

4. The assembly of claim 3, wherein
the gripping handle (20) is T-shaped, i.e., has an upper bar (20a) forming the equivalent of a “handlebar”, the upper bar (20a) comprising first connecting means (23) at its ends, and
the base (10) has lateral parts (15b) capable of covering the ends of the upper bar (20a) and has, at the lateral parts, second connecting means (22) capable of engaging with the first connecting means to achieve the connection of the base (10) to the gripping handle (20).

5. The assembly of claim 1, wherein
the push handle (6) has lower parts (6a) connected to upper parts (6b) by pivoting connections (16), the pivoting connections (16) allowing the push handle (6) to be placed either in an unfolded state, for pushing the stroller (2), or in a folded state, in which the lower parts (6a) and the upper parts (6b) are placed in a position close to the body (21) of the wheeled vehicle (3), along lateral sides of the body (21); and
the base (10) is pivotally connected to the pivoting connections (16) by means of mounting foils (15a) which offset the plane formed by the base (10) relative to the pivot axes formed by the pivoting connections (16), this offset allowing the base (10) to cover the body (21) of the vehicle (3) in the folded state.

6. The assembly of claim 1, wherein the gripping handle (20) is capable of being placed in two vertically staggered positions, namely a lowered position, allowing to reduce the footprint of the assembly of elements when not in use, and an elevated position, allowing to position the gripping handle (20) at a height suitable for gripping by the child riding the vehicle (3).

7. The assembly of claim 6, wherein the gripping handle (20) comprises a column (20b) forming a tubular portion (20b 1) while the body (21) of the vehicle (3) forms a tubular extension (21c) receiving the tubular portion in a telescopic manner, and comprises immobilization means (50, 51) allowing to immobilize the tubular portion (20b 1) and the tubular extension (21c) relative to each other in either of the two aforementioned positions of the gripping handle (20).

8. The assembly of claim 1, further comprising means (52 to 58) for positioning rear wheels (60) of the vehicle (3) in two spacing positions, namely a position of greater spacing, which is adopted in the “stroller” configuration of the assembly of elements, and a position of smaller spacing, which is adopted when the wheeled vehicle (3) is used as such or when the assembly of elements is in the folded state.

9. The assembly of claim 1, wherein the push handle (6) comprises, at its lower part and on its rear side, a strut (40) connected to a locking block (41), the block (41) being intended to engage with the body (21) of the vehicle (3) and thus allowing to lock the push handle (6) onto the body (21) in the unfolded state of the handle.
